(19) United States
(12) Patent Application Publication
(10) Pub. No.: US 2018/0354427 A1
(43) Pub. Date: Dec. 13, 2018

(54) Modular Rack

(71) Applicant: Ali Yazdian, Cottonwood Heights, UT (US)

(72) Inventor: Ali Yazdian, Cottonwood Heights, UT (US)

(21) Appl. No.: 16/003,082

(22) Filed: Jun. 7, 2018

Related U.S. Application Data
(60) Provisional application No. 62/516,184, filed on Jun. 7, 2017.

(51) Int. Cl. B60R 9/10; A45F 3/24; A47C 17/80; B60R 9/06

(52) U.S. Cl. CPC B60R 9/10; B60R 9/06; A47C 17/80; A45F 3/24

(57) ABSTRACT

A modular rack may feature top and bottom cross-beams mounted upon a central vertical post. A hitch structure may allow the rack to be mounted to a vehicle. Many stowage modules may be added to the rack, including a plurality of adjustable baskets for bicycles, a roof-rack simulator, a table and a hammock. A floor stand may receive the hitch structure and may allow of vehicle storage or storage in a truck bed. The baskets may be vertical or they may lean to one side to accommodate bicycles more efficiently. All modules may be positioned anywhere along the length of the cross-beams.

### CROSS-REFERENCES TO RELATED APPLICATIONS

The present Application claims priority as a non-provisional perfection of prior filed U.S. Application No. 62/516,184, filed Jun. 7, 2017, and incorporates the same by reference herein in its entirety.

### FIELD OF THE INVENTION

The present invention relates to the field of racks and holders and more particularly relates to a modular rack for holding, particularly, bicycles and other useful tools.

### BACKGROUND OF THE INVENTION

Racks have long been used to hold assorted items. The use of a rack keeps tools and other items organized so that they are easily accessed. Racks also are used to make use of “dead volume” or “empty space” where nothing would be readily stored, often being hung from ceilings or walls in a manner to keep items out of the way. Racks frequently are customized for a specific type of tool or item, such as a bike rack. Racks are also often placed on vehicles for storage of cargo. However, most racks are set in the type of cargo they can stow and they also block access to the rear of the vehicle (truck bed, van and SUV doors), preventing their use unless the rack is removed. Current rack assemblies also tend to be damaged when traversing rougher roads and while off-roading due to their low clearance. This is exacerbated in naturally low-clearance vehicles, such as mini-vans. In fact, rack clearance can be such a problem that, due to the extension of the cargo away from the vehicle, substantial amounts of cargo cannot be used in some low-clearance vehicles. The present invention is a modular rack for holding items from a central support. The items may be bicycles or other items. The central support may be mounted upon a vehicle or positioned on a floor support. Other supports, like a table, hammock, and bicycle repair arm, may also be mounted upon the modular rack.

The present invention represents a departure from the prior art in that the modular rack of the present invention allows for both vehicular and floor supported rack options. It also features adjustable basket holders and other holders for bicycles and other objects. It may also serve as a mount for a work table, work station or other useful objects.

### SUMMARY OF THE INVENTION

In view of the foregoing disadvantages inherent in the known types of racks, an improved modular rack may provide a rack that meets the following objectives: that it be convertible from stationary to vehicular use, that it features mounting structures for various objects and that said structures may be adjustable on the rack body, that various modules may be mounted upon the rack to increase its utility. As such, a new and improved modular rack may comprise a main rack body with a plurality of mounting baskets or other hardware for bicycles or other objects, a modular table attachment, a modular workstation attachment, and any other modular attachments desired by a user. It may also feature a vehicle mounting structure and a floor or wall mounting structure, such mounting structures possibly being removable from the main rack to accomplish these objectives.

The more notable features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in many ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a side elevation of one embodiment of a modular rack.

FIG. 2 is a front elevation of the modular rack of FIG. 1.

FIG. 3 is a perspective view of the modular rack of FIG. 1, mounted and in use.

FIG. 4 is an alternate perspective view of the modular rack of FIG. 1, in use.

FIG. 5 is a top plan view of a bicycle support basket for use with the modular rack of FIG. 1.

FIG. 6 is a side elevation of the bicycle support basket of FIG. 5.

FIG. 7 is a perspective view of the bicycle support basket of FIG. 5.

FIG. 8 is a front elevation of the bicycle support basket of FIG. 5.

FIG. 9 is a front elevation of an alternate bicycle support basket.

FIG. 10 is a front elevation of the top cross-beam of the rack of FIG. 1, with six mounted bicycle support baskets.

FIG. 11 is a perspective view of the bottom cross-beam with tire braces.

FIG. 12 is a side elevation of the bottom cross-beam of FIG. 11.

FIG. 13 is a perspective view of a floor mounting base for the rack of FIG. 1.

FIG. 14 is a side elevation of the floor mounting base of FIG. 13, in use.

FIG. 15 is a perspective view of a table module in use with the modular rack of FIG. 1.

FIG. 16 is a side elevation of the table module and modular rack of FIG. 13, stowed, with the table deployed in dashed lines.

FIG. 17 is a perspective view of the modular rack of FIG. 1, with a roof rack simulator module.

FIG. 18 is a perspective view of the modular rack of FIG. 1, with an attached hammock module.

### DETAILED DESCRIPTION OF THE PREFERRED EMBODIMENT

With reference now to the drawings, a preferred embodiment of the modular is herein described. It should be noted that the articles “a”, “an”, and “the”, as used in this specification, include plural referents unless the content clearly dictates otherwise.

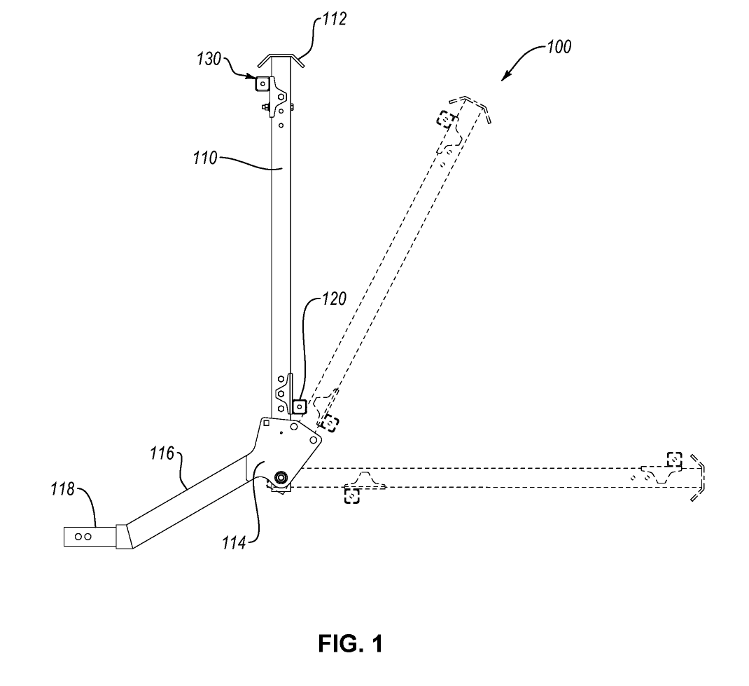

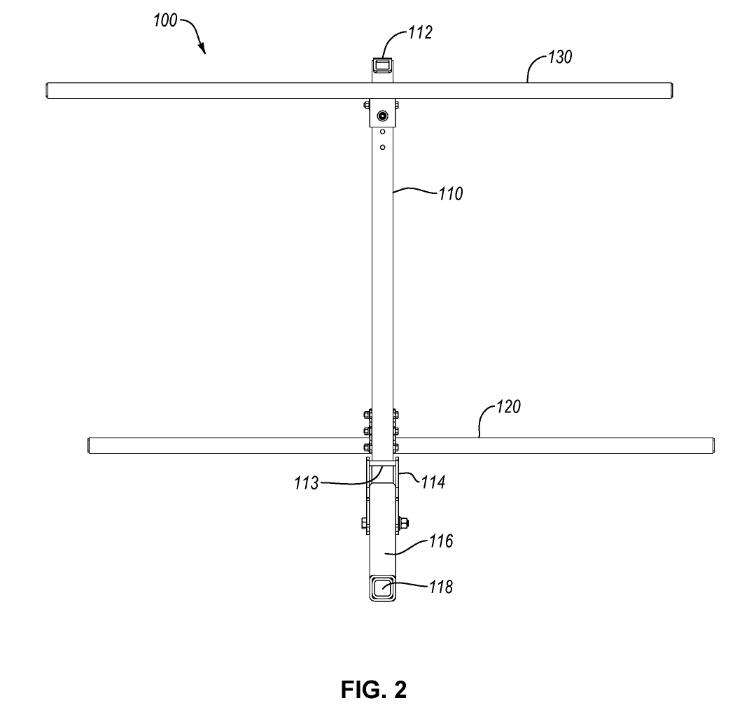

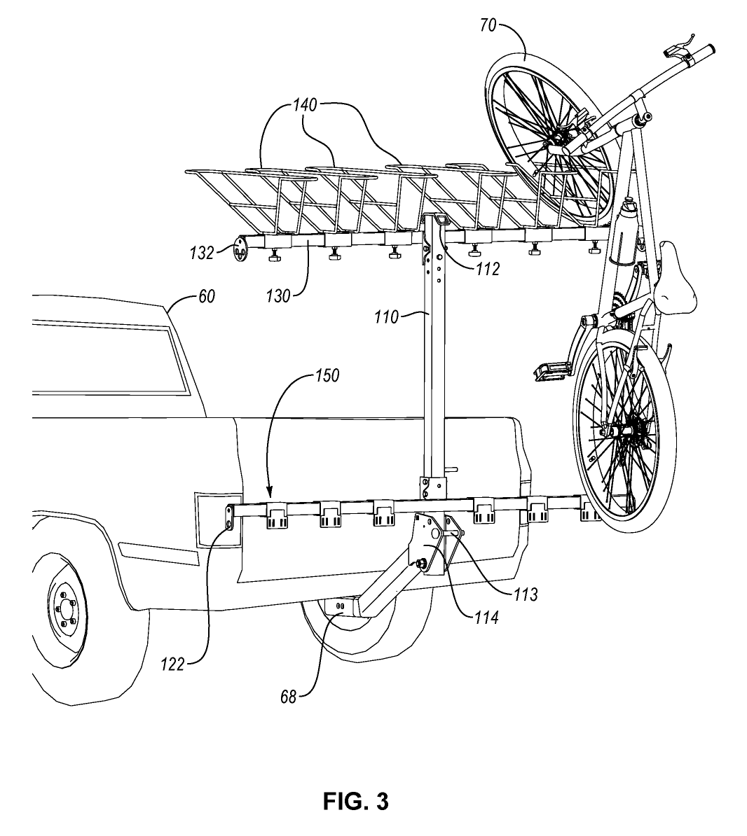

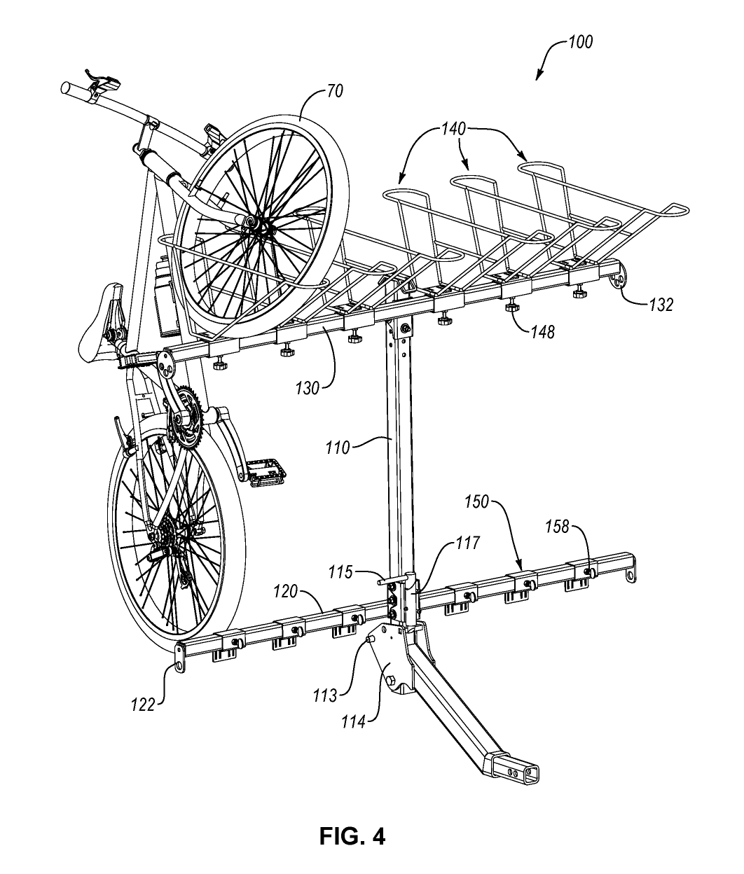

With reference to FIGS. 1 and 2, an exemplary modular rack 100 is a versatile rack system that adapts to an operator's desired use. The modular rack 100 features a central, vertical post 110 with two horizontal cross-beams mounted thereon 120, 130. The upper cross-beam 130 supports at least one support structure for a given object. Both beams may be made removable to accommodate other structural modules. Likewise, additional connection points may be made on the vertical post for additional structural modules, including additional cross-beams. The vertical post 110 features a tie-down anchor point 112 at its top and is pivotably set in a brace 114. The brace 114 extends to a distal trunk 116 and finally a hitch tongue 118. The hitch tongue 118 may then be inserted in a class three or higher 2-inch hitch receivers 68 of a vehicle 60 (FIG. 3). Trunk 116 is angled at approximately 15° to the hitch tongue to aid in obstacle clearance and traversing rough roads. This angle also allows use of the rack with lower-clearance vehicles. Brace 114 also provides an interface for a latch (FIG. 4). The latch sleeve 117 is mounted upon the vertical post 110 and spring-loaded latch bar 115 resides therein. The latch allows for single-handed manipulation of the rack's position relative to the vehicle. The latch bar 115 is biased to engage with a ridge in the brace 114 to keep the vertical post 110 in its vertical orientation. When latch is released, vertical post 110 may be rotated downwards to an intermediary position and is supported by an outer safety pin 113 located in two opposed holes in the brace 114. This outer safety pin 113 prevents the rack 100 from slamming downward entirely. It may be removed to allow full downward rotation and access to SUV doors, tailgates, and van double doors. It may also be placed in two corresponding holes, higher in the brace 114, for added securement of the rack 100 in cooperation with the latch structure.

In FIGS. 3-4, a plurality of wheel baskets 140 for bicycles are supported, as are lower tire braces 150. In its preferred embodiment, the modular rack may carry up to six bicycles sized between 20 to 29 inches with tire width up to 6 inches wide. More or fewer are, of course, possible and within the purview of the invention. The bikes 70 are supported in a vertical order and are side by side on the rack 110 behind the vehicle 60. The baskets 140 on the top vertical cross-beam 130 and tire braces on lower cross-beam 120 may be adjustable and can be completely removed to accommodate for other features. In the preferred embodiment, six baskets 140 and tire braces 150 are used to carry up to six bikes 90, though less are readily used and more may be used with a larger rack 100. These components' adjustability allows for the bikes' frames to avoid contact with the rack 100 and each other.

The cross-beams 120, 130 can be with round or square. The basket interface 140 and brace interface 150 can adapt to both shapes by use of a slider 142, 152 on which the components are mounted. The cross-beams 120, 130 in the preferred embodiment are 1.5-inches in width and the sliders 142, 152 may be manufactured of 1.75-inch square or round tubing. These may be secured to the cross-beams 120, 130 by any means now known or later discovered. This would include a bolt 148 or peg interface with bore holes in the cross-beams or a simple friction interface between bolt 148 and the surface of the cross-beams.

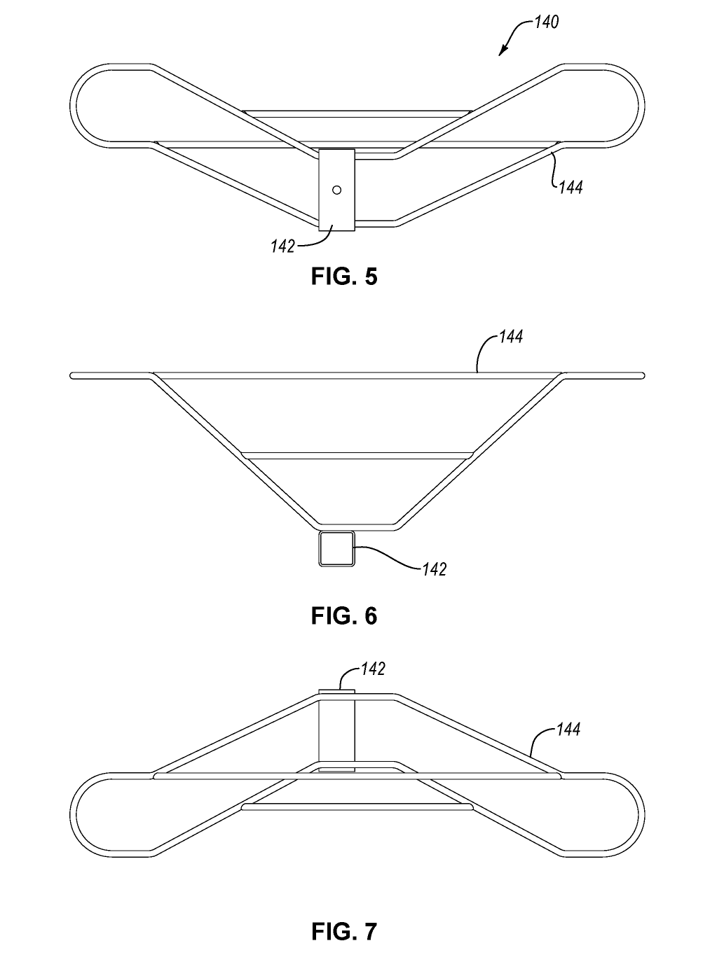

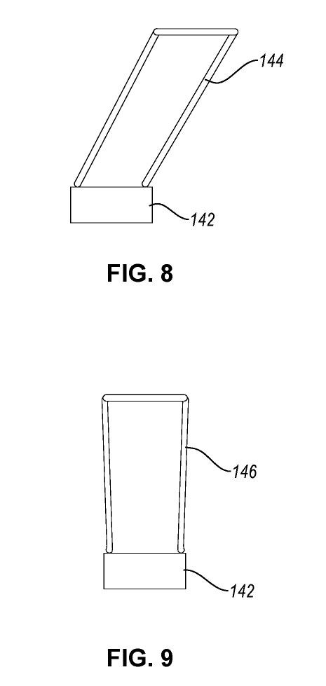

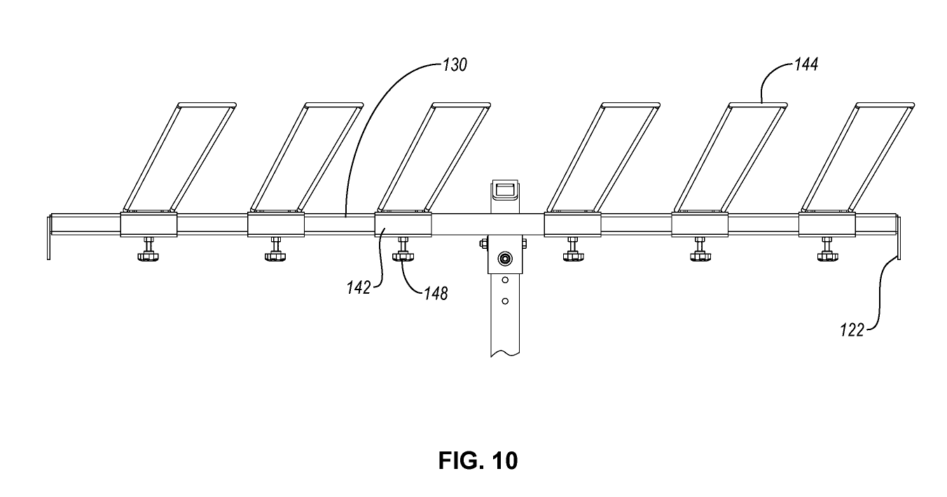

Baskets 140 (FIGS. 5-10) are mounted upon sliders 142 and may be made of various angles with the two most beneficial being what can be called a “regular lean” 144 and “no lean” 146. For a regular lean, wheel baskets 144 are leaned at angle between 26 degrees and 35 degrees. This allows for further space relief of the bikes. If the basket 146 has no lean it allows the operator to stand up the bikes on the ground, or in a bed of a pick-up truck, all using the top cross-beam 130 of the rack 100 for support.

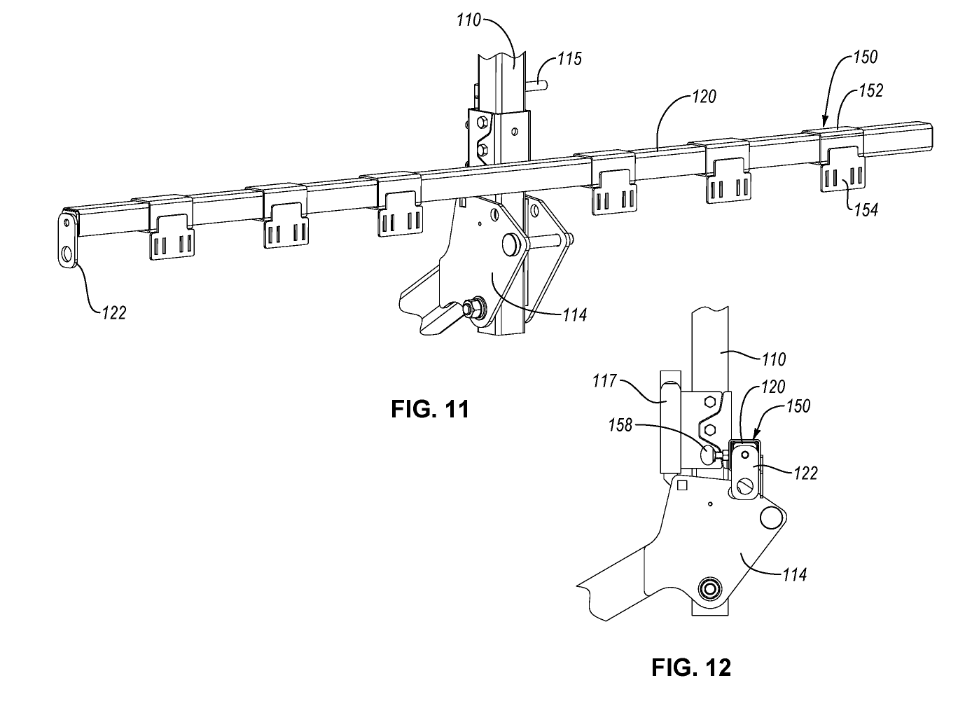

The bottom part of the basket 144 may taper relative to the top to allow for pinch grab function of the tire, typically the basket top width is 0.75 inch wider than the bottom width. Ideal basket sizes, whether regular lean or no lean, run from 3-inch to 6-inch top width, and 2.25-inch to 5.5-inch bottom width. A lower top wire on the left or lean side of the baskets allows for disc brake and caliper clearance. A strapping plate, accommodating a strap, is attached to the bottom of each basket for securing rubber straps to the front tires of any bicycles to be inside the basket. Otherwise, anchor points may be found on the top cross-beam 132 or bottom cross-beam 122 (FIGS. 3, 4, & 10). Tire braces 150 are similarly constructed (FIGS. 11-12) with a slider 152 supporting a brace wall 154, on which a rear tire may be strapped.

In a round tube version, the basket 140 can rotate on the axis defined by the top cross-beam 130. This action lowers the basket 140 to ease the interface with the bike 70. Once a bike is secured in the basket 140, the basket can be rotated up again and locked in place. Securement would be as previously described, utilizing bolt 148 to either interface with bores or merely friction lock with the surface of top cross-beam 130.

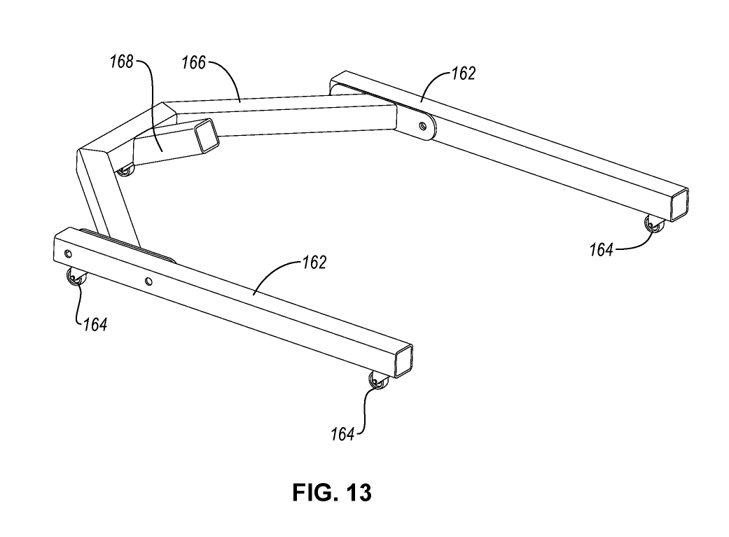

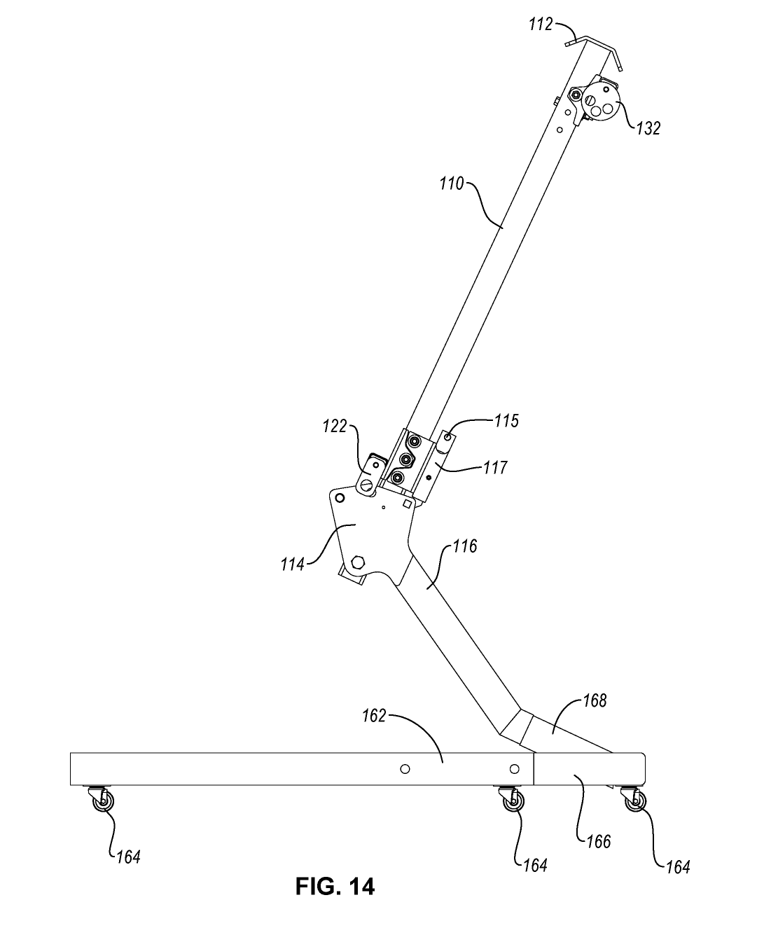

The modularity of the rack includes how it may be stowed and ported. A floor and truck bed stand 160 can be used for full bike storage or display (FIGS. 13 & 14). This stand 160 may hold the rack 110 in a slightly angled position for storage or display purposes. The stand frame may be constructed of two side bars 162 and a front yoke 166. Casters 164 on the side bars 162 and yoke 164 provide movement along a floor. An angled hitch receiver 168 receives the hitch tongue 118 as would that of a vehicle. The angle of the hitch receiver 168 positions the rack 100 over the stand 160 so that it supports the center of gravity of the stand. The stand 160 may be sized to fit inside the bed of a pickup truck or similar vehicle and simply secured to said vehicle when that is the intended use. It is preferred that the casters 164 be capable of locking.

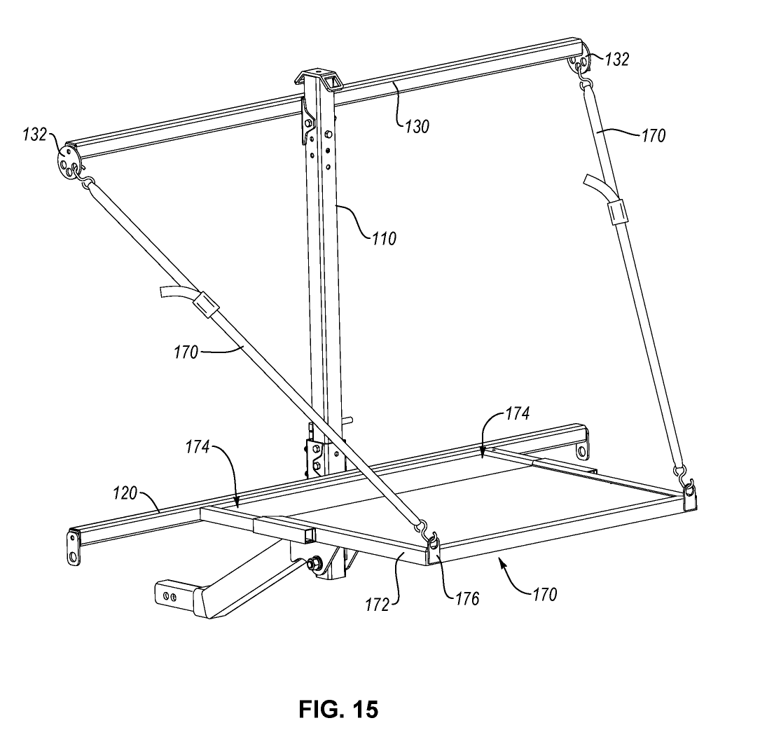

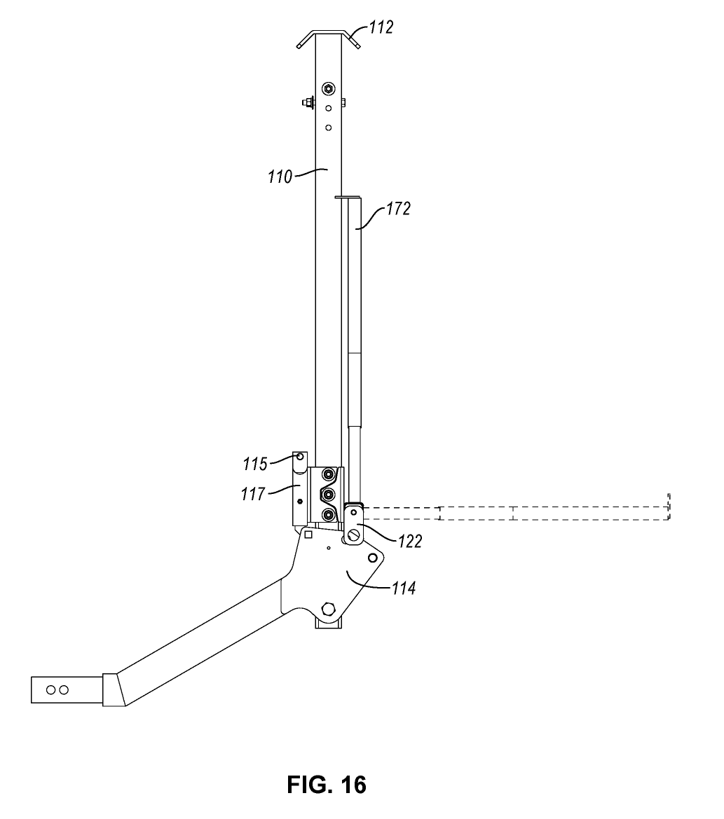

A work table 170 may be constructed from mesh or corrugated steel or aluminum, as shown in FIGS. 15 & 16. Table body 172 may be supported on bottom cross-beam 120 by two L-brackets 174, or similar structures, which define a channel and fit around the cross-beam 120. It may then be tensioned off of anchor point 112 of vertical post 110 using ties 178 connected to table anchors 176. When not in use, it is secured to the rack between the top vertical and bottom vertical beams by using the same channel mechanism. IN this manner, the table 170 may be stowed on the rack while it is holding cargo, including bicycles. The table may be 50 inches by 28 inches or any other useful size and may support up to 100 lbs. additional weight.

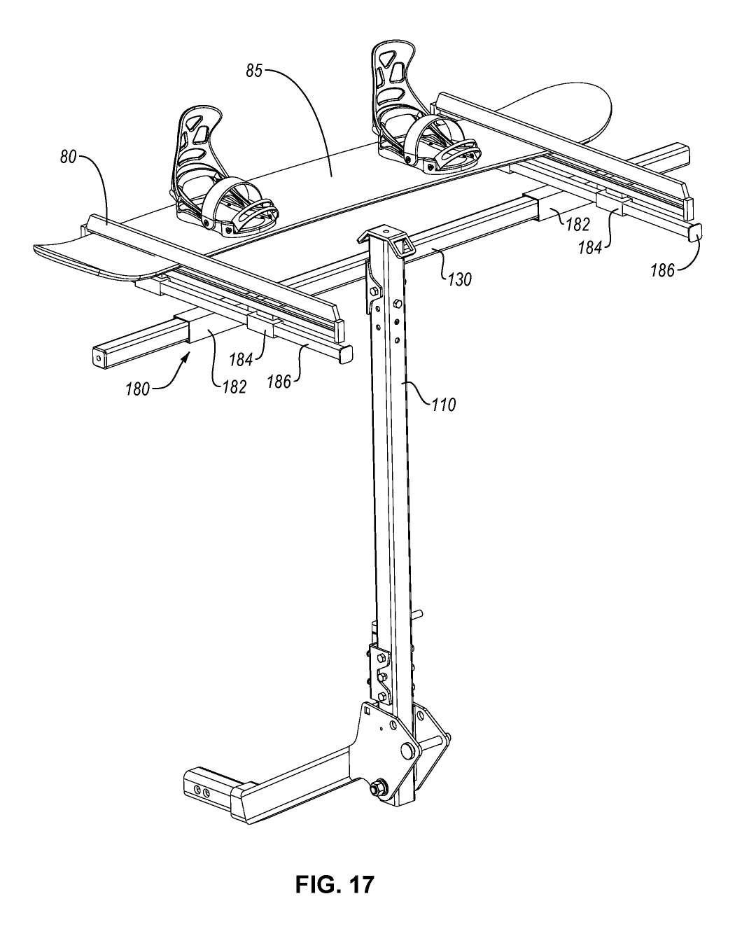

A roof-rack simulator 180 may be added to the modular rack, FIG. 17. In so doing, any carrier designed to fit on a vehicle's roof rack may be utilized with the modular rack. For instance, a snowboard carrier may be added to the module. The simulator 180 consists of two bars 186 cross-mounted on two sliding tubes 182. The slider tubes are constructed as are other slider tubes described herein. Snowboard holders 80 may be mounted on said bars 186 by mounts 184.

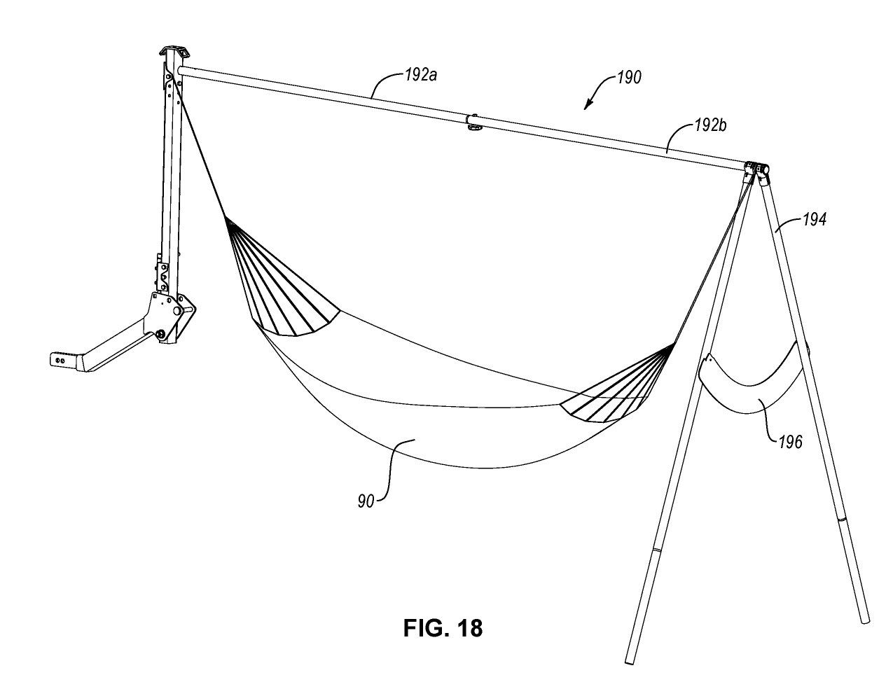

A hammock module may be a semi-tent shaped support frame constructed using the rack as support (FIG. 18). The operator can use any hammock 90 that fits. A first tube 192a accommodates a second 192b to complete a main support bar. This beam is then cantileverally attached to the rack and two angled legs 194 depend from the opposite side. A crosspiece 196 adds stability to the legs. The main support bar should be about 8 feet in total length, capable of breaking down in 4-foot sections which are secured by a bolt when in use. Legs 194 should have telescopic adjustment holes for height adjustment. The legs 194 should extend to 6 to 7-feet and break down in half or telescope. In this manner, the parts may be kitted in a carry bag.

Whether the bicycle baskets, roof-rack simulator, or any other modular stowage structure, each such structure would have as its base the slider tube structure with a corresponding attachment means to the supporting cross-beam. The preferred attachment means is the use of a bolt, such as bolts 148, 158 extending through one wall of the slider tubes to friction lock the structure on the cross-beam. As many such structures may be used as is reasonable given the circumstances of the type of module, number required, and size of the rack.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A modular stowage rack comprising:
a. a central vertical post with a top cross-beam and a lower cross-beam;
b. at least one modular stowage structure attachable to the top cross-beam, said at least modular stowage structure further comprising:
i. a storage body, and
ii. a slider tube, said slider tube attached to a bottom of the stowage module; and
c. a mounting body upon which the central rack post is mounted

2. The modular stowage rack of claim 1, the slider tube further comprising a bolt passing through one wall of the slider tube to interface with the top cross beam.

3. The modular stowage rack of claim 1, the at least one modular stowage body being a bike tire basket and further comprising at least one rear tire brace, further comprising a brace wall and a slider tube, mounted upon the lower cross-beam.

4. The modular stowage rack of claim 3, the at least one bike tire basket and the at least one rear tire brace both further comprising a bolt passing through one wall of their respective slider tubes to interface with the top and lower cross-beams respectively.

5. The modular stowage rack of claim 1, the mounting body further comprising a brace in which the vertical post is pivotably mounted and which in turn has a trunk depending therefrom, terminating in a hitch tongue.

6. The modular stowage rack of claim 5, the hitch tongue and trunk having an approximately 15° angle between them.

7. The modular stowage rack of claim 1, further comprising a table, stowable on the rack and supported thereon when in use.

8. The modular stowage rack of claim 1, the at least one modular stowage structure being two bars simulating a vehicle roof rack.

9. The modular stowage rack of claim 8, the slider tube further comprising a bolt passing through one wall of the slider tube to interface with the top cross-beam.

10. The modular stowage rack of claim 1, further comprising a support bar cantileverally supported on the modular stowage rack and having two legs depending from an opposite end, thereby forming a support frame.
